(19) United States
(12) Patent Application Publication
(10) Pub. No.: US 2026/0171513 A1
(43) Pub. Date: Jun. 18, 2026

(54) OUTPUT VOLTAGE CONTROL METHOD AND BATTERY DEVICE

(71) Applicant: Simplo Technology Co., Ltd., Hsinchu County (TW)

(72) Inventor: Shu-Hung Yeh, Hsinchu County (TW)

(73) Assignee: Simplo Technology Co., Ltd., Hsinchu County (TW)

(21) Appl. No.: 19/071,698

(22) Filed: Mar. 5, 2025

(30) Foreign Application Priority Data
Dec. 18, 2024 (TW) 113149381

(51) Int. Cl. H01M 10/42

(52) U.S. Cl. CPC H01M 10/425; H01M 10/4207; H01M 2010/4271; H01M 2010/4278; H01M 2200/00

(57) ABSTRACT

An output voltage control method for a battery device is provided. The output voltage control method includes detecting signal states of a data communication line and a clock communication line of a communication interface, and determining whether to enter a first-phase shutdown mode to control an output voltage of the battery device according to the signal states of the data communication line and the clock communication line and a first duration.

### BACKGROUND OF THE INVENTION

### 1. Field of the Invention

The present invention relates to an output voltage control method and a battery device, and more particularly, to an output voltage control method and a battery device capable of providing safety in use.

### 2. Description of the Prior Art

With the development of technology, mobile devices have become more and more popular, such as notebooks, tablets, cell phones, mobile communication devices. Mobile devices are usually equipped with batteries that store electrical energy to provide electrical power during operation of the mobile devices. As performance requirements and related applications for the mobile devices continue to increase, the power consumption would increase significantly. Therefore, the battery to be exhausted must be replaced in order to extend the operating life of the mobile device. As such, the user may often have to replace the battery by himself/herself in daily use. Further, during the battery replacement process, the battery output needs to be turned off to ensure the safety of the user and protect the battery from any accidental damage. Traditional method may control the output voltage of the battery by sending commands through a system host device. However, in daily use, the user usually does not actively operate and control the system host device to execute the commands for controlling the output voltage of the battery. As a result, the battery may still provide output voltage during the battery replacement process, thus leading to the risk of electric shock or short circuit. Thus, how to ensure the safety for the user while replacing the battery without affecting the function of the system device has become an important issue in the field.

### SUMMARY OF THE INVENTION

It is therefore a primary objective of the present invention to provide an output voltage control method and a battery device capable of providing safety in use, in order to resolve the aforementioned problems.

According to an embodiment of the present invention, an output voltage control method for a battery device is provided. The output voltage control method for a battery device includes detecting signal states of a data communication line and a clock communication line of a communication interface, and determining whether to enter a first-phase shutdown mode to control an output voltage of the battery device according to the signal states of the data communication line and the clock communication line, and a first duration.

According to an embodiment of the present invention, a battery device is provided. The battery device includes a battery pack, configured to output an output voltage; a communication interface, comprising a data communication line and a clock communication line; a battery identification pin; and a processor, configured to implement the above-mentioned output voltage control method of claim 1 according to signal states of the data communication line, the clock communication line and the battery identification pin.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the present invention.

FIG. 2 and FIG. 3 are schematic diagrams of the procedure according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

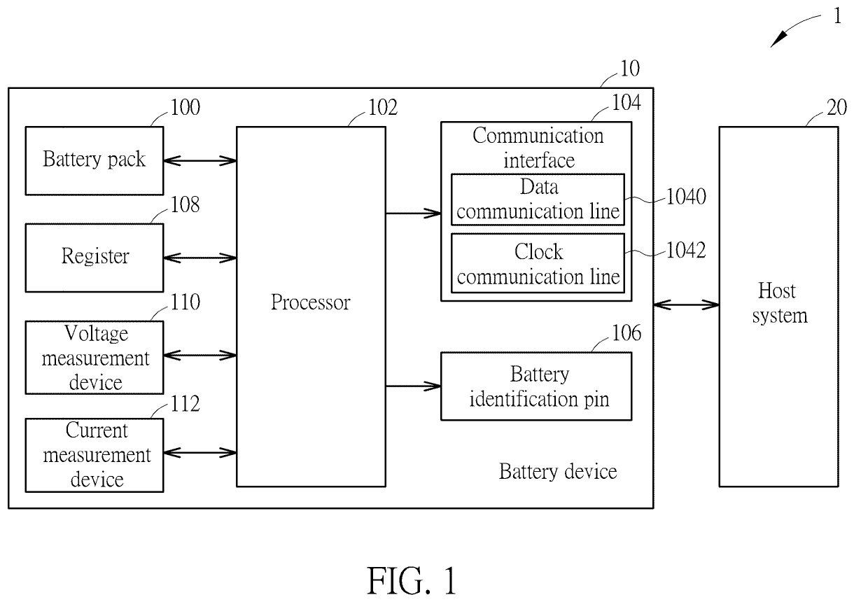

Please refer to FIG. 1, which is a schematic diagram of an electronic system 1 according to an embodiment of the present invention. The electronic system 1 can be a notebook, a tablet, a cell phone, a mobile communication device, a wearable device, a drone, an unmanned aerial vehicle, but not limited thereto. The electronic system 1 includes a battery device 10 and a host system 20. The battery device 10 may provide electrical energy to the electronic system 1 for operations. For example, the battery device 10 may output an output voltage to provide electrical energy to the host system 20. The battery device 10 includes a battery pack 100, a processor 102, a communication interface 104, a battery identification (ID) pin 106, a register 108, a voltage measurement device 110 and a current measurement device 112. The battery pack 100 may output an output voltage to provide electrical energy. The battery pack 100 may include one or more batteries. The number and connection arrangement of batteries of the battery pack 100 may be designed according to system requirements. The battery of the battery pack 100 may be a lithium iron phosphate battery, a nickel-cadmium battery, a nickel-metal hydride battery, a lithium-ion battery, a sodium-based battery, or a lead-acid battery, but not limited thereto. The processor 102 may be a micro control unit (MCU), a central processing unit (CPU), a microprocessor, or an embedded controller (EC), but not limited thereto.

The battery device 10 can communicate with the host system 20 or an external device through the communication interface 104. The communication interface 104 includes a data communication line 1040 and a clock communication line 1042. The processor 102 may be coupled to the communication interface 104 to detect signal states of the data communication line 1040 and the clock communication line 1042. The processor 102 may receive related communication information transmitted on or transmitted through the communication interface 104. For example, the communication information may be data, instructions, messages or any other information associated with the communication interface. The communication interface 104 may be a system management bus (SMBus), an inter-integrated circuit (I²C) bus interface, a universal serial bus (USB) interface, but not limited thereto. The battery device 10 can also communicate with the host system 20 or an external device through the battery identification pin 106. The processor 102 may be coupled to the battery identification pin 106 to detect a signal state of the battery identification pin 106. The register 108 is utilized for storing related information of the battery device 10. The voltage measurement device 110 is utilized for measuring the voltage of the battery pack 100. The current measurement device 112 is utilized for measuring the current of the battery pack 100.

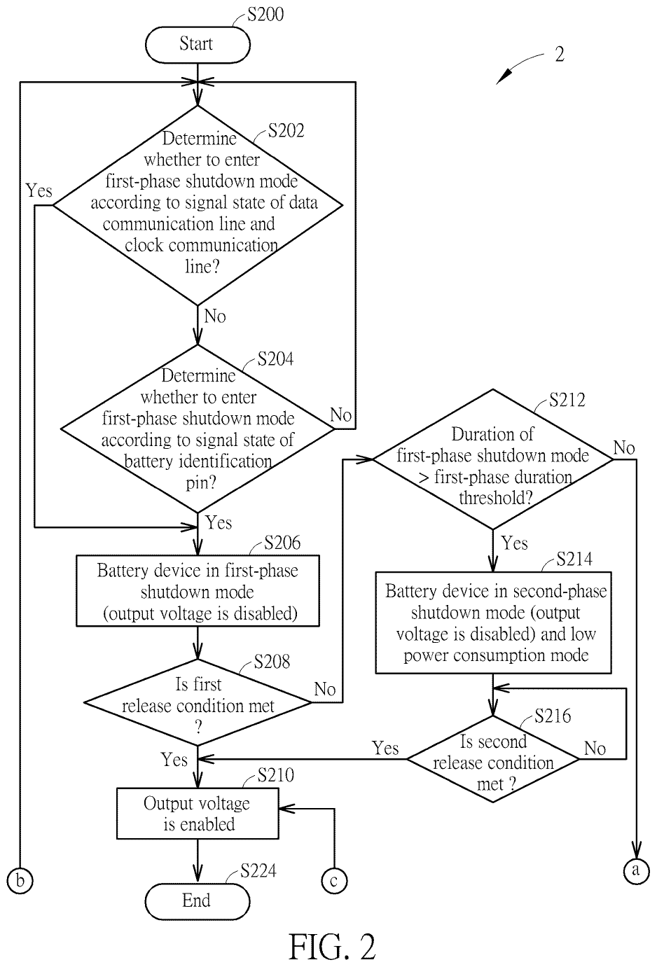

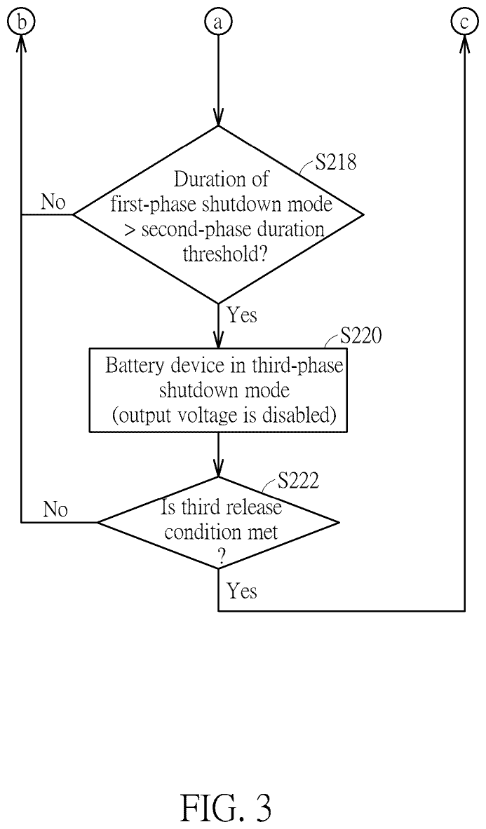

Further description associated with detailed operations of an output voltage control method of the battery device 10 is provided as follows. Please refer to FIG. 2 and FIG. 3, which are schematic diagrams of a procedure 2 according to an embodiment of the present invention. According to the procedure 2, in Step S202, the processor 102 is configured to detect signal states of the data communication line 1040 and the clock communication line 1042 of the communication interface 104. The processor 102 may determine whether to enter a first-phase shutdown mode to control an output voltage of the battery device 10 according to the signal state of the data communication line 1040, the signal state of the clock communication line and a first duration. The processor 102 may determine whether a signal level of the data communication line 1040 and a signal level of the clock communication line 1042 are both at a first level (e.g., logic low level). Based on determining that the signal levels of the data communication line 1040 and the clock communication line 1042 are both at the first level, the processor 102 may determine whether a duration that the signal levels of the data communication line 1040 and the clock communication line 1042 are both at the first level is greater than the first duration. When determining that the duration that the signal levels of the data communication line 1040 and the clock communication line 1042 are both at the first level is greater than the first duration, the Step S206 is executed. The battery device 10 may be controlled to enter the first-phase shutdown mode and the output voltage of the battery device 10 may be disabled by the processor 102, such that the battery device 10 does not output the output voltage (Step S206).

In Step S202, when the processor 102 determines that the signal level of the data communication line 1040 and the signal level of the clock communication line 1042 are not both at the first level (i.e. the signal level of at least one of the data communication line 1040 and the clock communication line 1042 is at a second level (e.g., logic high level), the battery device 10 continues to operate normally to output the output voltage, and the Step S204 is executed. In addition, when the processor 102 determines that the duration that the data communication line 1040 and the clock communication line 1042 are both at the first level is less than or equal to the first duration, the battery device 10 continues to operate normally to output the output voltage, and the Step S204 is executed.

In Step S204, the processor 102 may determine whether to enter the first-phase shutdown mode to control an output voltage of the battery device 10 according to a signal state of the battery identification pin 106 and a second duration. The processor 102 may determine whether a signal level of the battery identification pin 106 is at a first pin level (e.g., logic low level). The processor 102 may determine whether a duration that the signal level of the battery identification pin 106 is at the first pin level is greater than the second duration. Based on determining that the duration that the signal level of the battery identification pin 106 is at the first pin level is greater than the second duration, the Step S206 is executed. The battery device 10 may be controlled to enter the first-phase shutdown mode and the output voltage of the battery device 10 may be disabled by the processor 102, such that the battery device 10 does not output the output voltage (Step S206). In Step S204, when the processor 102 determines that the signal level of the battery identification pin 106 is at a second pin level (e.g., logic high level), the battery device 10 continues to operate normally to output the output voltage, and the procedure returns to Step S202. When the processor 102 determines that the duration that the battery identification pin 106 is at the first pin level (e.g., logic low level) is less than or equal to the second duration, the battery device 10 continues to operate normally to output the output voltage, and the procedure returns to Step S202.

In Step S206, the processor 102 may control the battery device 10 to enter the first-phase shutdown mode and disable the output voltage of the battery device 10, such that the battery device 10 does not output the output voltage during the first-phase shutdown mode. In other words, the battery device 10 enters the first-phase shutdown mode and the processor 102 controls the battery pack 100 of the battery device 10 to stop outputting the output voltage. Therefore, during the first-phase shutdown mode, the battery device 10 does not generate and output the output voltage. As such, the user can safely replace the battery by himself or herself without the risk of electric shock, thus ensuring safety during use and avoiding unnecessary trouble and losses.

For example, the communication interface 104 is a system management bus. The first level may be a logic low level, and the second level may be a logic high level. The processor 102 may determine whether the signal levels of the data communication line 1040 and the clock communication line 1042 are both at the logic low level. Moreover, the processor 102 may determine whether the signal levels of the data communication line 1040 and the clock communication line 1042 are both at the logic low level and have lasted for more than a first duration (Step S202). When the processor 102 determines that a duration that the signal levels of the data communication line 1040 and the clock communication line 1042 are both at the first level is greater than the first duration, the processor 102 controls the battery device 10 to enter the first-phase shutdown mode and disables the output voltage of the battery device 10, such that the battery device 10 does not output the output voltage (Step S206). For example, the first pin level may be a logic low level, and the second pin level may be a logic high level. The processor 102 may determine whether the battery identification pin 106 is at the logic low level and has lasted for more than a second duration (Step S204). When the processor 102 determines that a duration of the battery identification pin 106 being at the logic low level is greater than the second duration, the processor 102 may control the battery device 10 to enter the first-phase shutdown mode and disable the output voltage of the battery device 10, such that The battery device 10 does not output the output voltage during the first-phase shutdown mode (Step S206).

Since the battery device 10 has entered into the first-phase shutdown mode in Step S206. In Step S208, the processor 102 may determine whether a first release condition is met according to at least one of the data communication line 1040 and the clock communication line 1042 of the communication interface 104; meanwhile the battery identification pin 106 and communication information of the communication interface 104 is still in the first-phase shutdown mode. For example, the first release condition includes at least one of the following: the signal level of at least one of the data communication line 1040 and the clock communication line 1042 is at the second level (e.g., logic high level) during the first-phase shutdown mode; there is communication information in the communication interface 104 during the first-phase shutdown mode; and the signal level of the battery identification pin 106 is at a second pin level (e.g., logic high level) during the first-phase shutdown mode. For example, the communication interface 104 is a system management bus. The processor 102 may continue to detect the data communication line 1040 and the clock communication line 1042 during the first-phase shutdown mode. When determining that either the signal level of the data communication line 1040 or the clock communication line 1042 is at the logic high level or both of them are at the logic high level, the processor 102 determines that the first release condition is met. For example, the processor 102 may continue to detect the battery identification pin 106 during the first-phase shutdown mode. When determining that the signal level of the battery identification pin 106 is at the logic high level, the processor 102 determines that the first release condition is satisfied. For example, the processor 102 may detect whether any communication information is being transmitted via the communication interface 104 during the first-phase shutdown mode. For example, the communication information may be data, instructions, messages or any other information associated with the communication interface 104. When the processor 102 receives communication information of the communication interface 104 or detects communication information transmitted in the communication interface 104, this means that there is communication information in the communication interface 104, such that the processor 102 determines that the first release condition is met.

In Step S208, when determining that any of the first release conditions is satisfied, the processor 102 may control the battery device 10 to switch into a normal operation mode (i.e., switch from the first-phase shutdown mode to the normal operation mode). The output voltage of the battery device 10 may be enabled and turned on by the processor 102, such that the battery device 10 operates normally to output the output voltage, and the Step S210 is executed. When the processor 102 determines that the first release condition is not satisfied (no condition in the first release condition is satisfied), the Step S212 is executed and the battery device 10 still operates in the first-phase shutdown mode.

In Step S210, the battery device 10 operates in the normal operation mode and the output voltage of the battery device 10 is enabled. The battery device 10 may generate the output voltage to provide electrical energy.

In Step S212, the battery device 10 still operates in the first-phase shutdown mode. In the first-phase shutdown mode, the processor 102 may determine whether a duration of the first-phase shutdown mode is greater than a first-phase duration threshold. The duration of the first-phase shutdown mode represents the time length from the time point when the battery device 10 enters the first-phase shutdown mode to the current time point. During the duration of the first-phase shutdown mode, the battery device 10 is continuously in the first-phase shutdown mode. When determining that the duration of the first-phase shutdown mode is greater than the first-phase duration threshold, the Step s214 is executed. The processor 102 may control the battery device 10 to enter a second-phase shutdown and a low power consumption mode. When determining that the duration of the first-phase shutdown mode is less than or equal to the first-phase duration threshold, the Step S218 is executed.

In Step S214, the processor 102 controls the battery device 10 to enter the second-phase shutdown mode and a low power consumption mode. The output voltage of the battery device 10 is disabled by the processor 102. As such, the battery device 10 does not output the output voltage during the second-phase shutdown mode. Moreover, since the battery device 10 has entered the low power consumption mode, the power consumption of the battery device 10 can be further reduced.

Since the battery device 10 has entered into the second-phase shutdown mode in Step S214. In Step S216, the processor 102 may determine whether at least one of second release conditions is met in the second-phase shutdown mode among the status of: the data communication line 1040 and the clock communication line 1042 of the communication interface 104, the battery identification pin 106 and communication information of the communication interface 104. For example, the second release condition includes at least one of the following: the signal level of at least one of the data communication line 1040, the clock communication line 1042 and battery identification pin 106 changes during the second-phase shutdown mode; a wake-up procedure is executed during the second-phase shutdown mode; and there is communication information in the communication interface during the second-phase shutdown mode. When determining that any of the second release conditions is satisfied, the processor 102 may control the battery device 10 to switch into the normal operation mode (i.e., switch from the second-phase shutdown mode to the normal operation mode). The output voltage of the battery device 10 may be enabled by the processor 102, such that the battery device 10 operates normally to output the output voltage, and the Step S210 is executed. When the processor 102 determines that the second release condition is not satisfied (no condition in the second release condition is satisfied), the Step S216 is executed again. That is, when determining that the second release conditions is satisfied, the Step S216 is repeatedly executed until the processor 10 determines that any of the second release conditions is satisfied.

In Step S218, the battery device 10 still operates in the first-phase shutdown mode. In the first-phase shutdown mode, the processor 102 may determine whether the duration of the first-phase shutdown mode is greater than a second-phase duration threshold. The second-phase duration threshold may be less than the first-phase duration threshold. For example, the time unit of first-phase duration threshold could be days and the time unit of the second-phase duration threshold could be hours. For example, the time unit of first-phase duration threshold may be set to be one day, and the time unit of the second-phase duration threshold may be set to be one hour. When determining that the duration of the first-phase shutdown mode is greater than the second-phase duration threshold, the Step S220 is executed. The processor 102 may control the battery device 10 to enter a third-phase shutdown. When determining that the duration of the first-phase shutdown mode is less than or equal to the second-phase duration threshold, the procedure returns to Step S202, and the battery device 10 still operates in the first-phase shutdown mode.

In Step S220, the processor 102 may control the battery device 10 to enter the third-phase shutdown mode and the output voltage of the battery device 10 may be disabled by the processor 102, such that the battery device 10 does not output the output voltage during the third-phase shutdown mode. Since the battery device 10 has entered into the third-phase shutdown mode in Step S220. In Step S222, the processor 102 may determine whether a third release condition is met according to at least one of the data communication line 1040 and the clock communication line 1042 of the communication interface 104, the battery identification pin 106 and communication information of the communication interface 104 in the third-phase shutdown mode. For example, the third release condition includes at least one of the following: the signal level of at least one of the data communication line 1040, the clock communication line 1042 and battery identification pin 106 changes during the third-phase shutdown mode; and there is communication information in the communication interface 104 during the third-phase shutdown mode. When determining that any one of the third release conditions is satisfied, the processor 102 may control the battery device 10 to switch into the normal operation mode (i.e., switch from the third-phase shutdown mode to the normal operation mode). The output voltage of the battery device 10 may be enabled and turned on by the processor 102, such that the battery device 10 operates normally to output the output voltage, and the Step S210 is executed. When the processor 102 determines that the third release condition is not satisfied (no condition in the third release condition is satisfied), the procedure returns to Step S202.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. Examples of hardware can include analog, digital and/or mixed circuits known as microcircuit, microchip, or silicon chip. Examples of the electronic system may include a system on chip (SoC), system in package (SiP), a computer on module (CoM) and the electronic system 1. Any of the abovementioned procedures and examples above may be compiled into program codes or instructions that are stored in a storage device. The storage device may include a computer-readable storage medium. The storage device may include may include read-only memory (ROM), flash memory, random-access memory (RAM), subscriber identity module (SIM), hard disk, floppy diskette, or CD-ROM/DVD-ROM/BD-ROM, but not limited thereto. The processor 102 may read and execute the program codes or the instructions stored in the storage device for realizing the abovementioned functions.

To sum up, the embodiments of the present invention provide an output voltage control method for a battery device. By using the embodiments of the present invention, the output voltage can be automatically disabled while the battery device is removed from the host system. Therefore, the user can safely replace the battery by himself or herself without the risk of electric shock, thus ensuring safety during use and avoiding unnecessary trouble and losses. More particularly, since the data communication line and the clock communication line of the communication interface and the battery identification pin have already been used in the existing battery system architecture, the embodiments of the present invention do not need to include an additional hardware circuits for implementing the abovementioned-method, thus the manufacturing cost can be effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An output voltage control method for a battery device, comprising:
detecting signal states of a data communication line and a clock communication line of a communication interface, and
determining whether to enter a first-phase shutdown mode to control an output voltage of the battery device according to the signal states of the data communication line and the clock communication line, and a first duration.

2. The output voltage control method of claim 1, further comprising:
determining whether signal levels of the data communication line and the clock communication line are both at a first level;
determining whether a duration that the signal levels of the data communication line and the clock communication line are both at the first level is greater than the first duration based on determining that the signal levels of the data communication line and the clock communication line are both at the first level; and
controlling the battery device to enter the first-phase shutdown mode and disabling the output voltage of the battery device such that the battery device does not output the output voltage based on determining that the duration that the signal levels of the data communication line and the clock communication line are both at the first level is greater than the first duration.

3. The output voltage control method of claim 1, further comprising:
detecting a signal state of a battery identification pin and determining whether a signal level of the battery identification pin is at a first pin level based on determining that a signal level of at least one of the data communication line and the clock communication line is not at a first level or a duration that the signal levels of the data communication line and the clock communication line are both at the first level is less than or equal to the first duration; and
controlling the battery device to enter the first-phase shutdown mode and disabling the output voltage of the battery device such that the battery device does not output the output voltage based on determining that the signal level of the battery identification pin is at the first pin level and a duration that the signal level of the battery identification pin is at the first pin level is greater than a second duration.

4. The output voltage control method of claim 1, further comprising:
the battery device entering into the first-phase shutdown mode;
determining whether a first release condition is met according to at least one of the data communication line and the clock communication line of the communication interface, a battery identification pin and communication information of the communication interface in the first-phase shutdown mode; and
when determining that the first release condition is met, controlling the battery device to switch into a normal operation mode and enabling the output voltage of the battery device, such that the battery device operates normally to output the output voltage.

5. The output voltage control method of claim 4, wherein the first release condition comprises at least one of the following:
a signal level of at least one of the data communication line and the clock communication line being at a second level during the first-phase shutdown mode;
there is communication information in the communication interface during the first-phase shutdown mode; and
a signal level of the battery identification pin being at a second pin level during the first-phase shutdown mode.

6. The output voltage control method of claim 1, further comprising:
the battery device entering into the first-phase shutdown mode;
determining whether a duration of the first-phase shutdown mode is greater than a first-phase duration threshold in the first-phase shutdown mode; and
when determining that the duration of the first-phase shutdown mode is greater than the first-phase duration threshold, controlling the battery device to enter a second-phase shutdown and a low power consumption mode, and disabling the output voltage of the battery device, such that the battery device does not output the output voltage.

7. The output voltage control method of claim 6, further comprising:
determining whether a second release condition is met according to at least one of the data communication line and the clock communication line of the communication interface, a battery identification pin and communication information of the communication interface in the second-phase shutdown mode; and
when determining that the second release condition is met, controlling the battery device to switch into a normal operation mode and enabling the output voltage of the battery device, such that the battery device operates normally to output the output voltage.

8. The output voltage control method of claim 7, wherein the second release condition comprises at least one of the following:
a signal level of at least one of the data communication line, the clock communication line and the battery identification pin changes during the second-phase shutdown mode;
a wake-up procedure is executed during the second-phase shutdown mode; and
there is communication information in the communication interface during the second-phase shutdown mode.

9. The output voltage control method of claim 6, further comprising:
when determining that the duration of the first-phase shutdown mode is less than or equal to the first-phase duration threshold, determining whether the duration of the first-phase shutdown mode is greater than a second-phase duration threshold, wherein the second-phase duration threshold is less than the first-phase duration threshold; and
controlling the battery device to enter a third-phase shutdown, and disabling the output voltage of the battery device, such that the battery device does not output the output voltage based on determining that the duration of the first-phase shutdown mode is greater than the second-phase duration threshold.

10. The output voltage control method of claim 9, further comprising:
determining whether a third release condition is met according to at least one of the data communication line and the clock communication line of the communication interface, a battery identification pin and communication information of the communication interface in the third-phase shutdown mode; and
when determining that the third release condition is met, controlling the battery device to switch into a normal operation mode and enabling the output voltage of the battery device, such that the battery device operates normally to output the output voltage.

11. The output voltage control method of claim 10, wherein the third release condition comprises at least one of the following:
a signal level of at least one of the data communication line, the clock communication line and the battery identification pin changes during the third-phase shutdown mode; and
there is communication information in the communication interface during the third-phase shutdown mode.

12. The output voltage control method of claim 1, wherein the communication interface is a system management bus.

13. A battery device, comprising:
a battery pack, configured to output an output voltage;
a communication interface, comprising a data communication line and a clock communication line;
a battery identification pin; and
a processor, configured to implement the output voltage control method of claim 1 according to signal states of the data communication line, the clock communication line and the battery identification pin.
